(19) United States
(12) Patent Application Publication
(10) Pub. No.: US 2023/0053495 A1
(43) Pub. Date: Feb. 23, 2023

(54) COMPARABLE ITEM IDENTIFICATION FOR QUERY ITEMS

(71) Applicant: Verizon Media Inc., New York, NY (US)

(72) Inventors: Kimberly WILLIAMS, Burbank, CA (US); Eric Theordore BAX, Sierra Madre, CA (US); Tanisha SHARMA, Playa Vista, CA (US); William W. WAGNER, Costa Mesa, CA (US); Nikki Mia THOMPSON, Playa Visat, CA (US); Lisa GIAFFO, Pasadena, CA (US)

(21) Appl. No.: 17/404,219

(22) Filed: Aug. 17, 2021

(51) Int. Cl. G06F 16/9532; G06F 16/957; G06F 16/9538

(52) U.S. Cl. CPC G06F 16/9532; G06F 16/9574; G06F 16/9538

(57) ABSTRACT

One or more computing devices, systems, and/or methods for providing comparable items for a query item are provided. A query is constructed based upon a set of similarity characteristics and a set of difference characteristics specified for a query item. The query is executed to identify a set of query item results comprising comparable items having characteristics similar to the set of similarity characteristics and characteristics different from the set of difference characteristics. The set of query item results are provided as query results for the query.

### BACKGROUND

Many service providers may provide users with access to items, such as images, news stories, social network feeds, webpages, videos, and/or other types of content. Some of these service providers may provide users with the ability to search for certain content. For example, a user may submit a search query for “best roleplaying videogames” through a website. The website may identify articles, videos, and/or other content that best matches the search query “best roleplaying videogames” as search results. The search results may be provided back to the user, such as through the website.

### SUMMARY

In accordance with the present disclosure, one or more computing devices and/or methods for providing comparable items for a query item are provided. Items, such as news stories, memes, videos, text, images, and/or a variety of other content, may be evaluated utilizing various types of techniques (e.g., text and image analysis, editorial labeling, crowd sourcing, etc.) to identify characteristics of the items. In an example, the characteristics may correspond to veracity/innuendo, editorial opinion vs reporting, political leaning of a subject or a message, tone, whether a topic is about a person, an event, or an idea, a subject of the topic, a category of the topic (e.g., sports, fashion, etc.), a time of the topic, a time at which the item was created, a source or creator of the item, a publisher of the item, etc. The items may be stored within a data structure, such as a database, indexed by the categories and values of the categories.

A query item may comprise an item with characteristics that are used to obtain query results of comparable items that may be provided to a user and/or used to construct a media item. For example, the query item may comprise an article with a topic of a particular football player, a subject regarding the football player making a particular gesture, and a negative tone. A set of similarity characteristics may be determined for the query item, such as a similar subject regarding a football player making a gesture. A set of difference characteristics may be determined for the query item, such as a topic about different football players and a tone that is positive so that the difference characteristics can be used to identify comparable items about different football players and that have a positive tone.

A query may be constructed based upon the set of similarity characteristics and the set of difference characteristics. The query may be constructed with a metric that favors items with characteristics similar to the set of similarity characteristics so that the query may return items that have similar characteristics as the set of similarity characteristics (e.g., items with characteristic values that are similar to characteristic values of the query item, such as items about football players making gestures). The query may be constructed with a metric that favors items with characteristics that are dissimilar to the set of difference characteristics so that the query may return items that have different characteristics as the set of difference characteristics (e.g., items with characteristic values that are dissimilar to characteristic values of the query item, such as items about different football players and items with positive tones).

The query may be executed upon the data structure, such as the database, in order to identify a set of query item results. The set of query item results comprise comparable items having characteristics similar to the set of similarity characteristics (e.g., items with characteristic values that are similar to characteristic values of the query item, such as items about football players making gestures) and with characteristics dissimilar to the set of difference characteristics (e.g., items with characteristic values that are dissimilar to characteristic values of the query item, such as items about different football players and items with positive tones). In this way, the set of query item results may be provided as query results for the query, such as for display to a user or for inclusion within a media item for display to the user.

### DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is an illustration of a scenario involving various examples of networks that may connect servers and clients.

FIG. 2 is an illustration of a scenario involving an example configuration of a server that may utilize and/or implement at least a portion of the techniques presented herein.

FIG. 3 is an illustration of a scenario involving an example configuration of a client that may utilize and/or implement at least a portion of the techniques presented herein.

FIG. 4 is a flow chart illustrating an example method for providing comparable items for a query item.

FIG. 5 is a component block diagram illustrating an example system for providing comparable items for a query item.

FIG. 6 is a component block diagram illustrating an example system for providing comparable items for a query item.

FIG. 7 is a component block diagram illustrating an example system for providing comparable items for a query item.

FIG. 8 is a component block diagram illustrating an example system for providing comparable items for a query item.

FIG. 9 is an illustration of a scenario featuring an example non-transitory machine readable medium in accordance with one or more of the provisions set forth herein.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

1. Computing Scenario

The following provides a discussion of some types of computing scenarios in which the disclosed subject matter may be utilized and/or implemented.

1.1. Networking

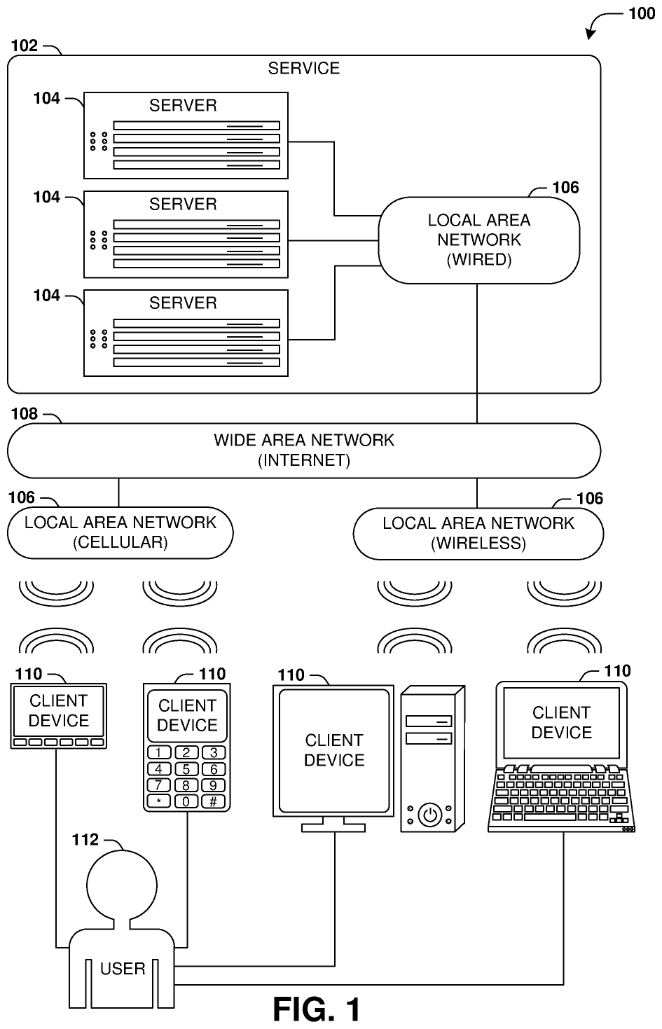

FIG. 1 is an interaction diagram of a scenario 100 illustrating a service 102 provided by a set of servers 104 to a set of client devices 110 via various types of networks. The servers 104 and/or client devices 110 may be capable of transmitting, receiving, processing, and/or storing many types of signals, such as in memory as physical memory states.

The servers 104 of the service 102 may be internally connected via a local area network 106 (LAN), such as a wired network where network adapters on the respective servers 104 are interconnected via cables (e.g., coaxial and/or fiber optic cabling), and may be connected in various topologies (e.g., buses, token rings, meshes, and/or trees). The servers 104 may be interconnected directly, or through one or more other networking devices, such as routers, switches, and/or repeaters. The servers 104 may utilize a variety of physical networking protocols (e.g., Ethernet and/or Fiber Channel) and/or logical networking protocols (e.g., variants of an Internet Protocol (IP), a Transmission Control Protocol (TCP), and/or a User Datagram Protocol (UDP). The local area network 106 may include, e.g., analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. The local area network 106 may be organized according to one or more network architectures, such as server/client, peer-to-peer, and/or mesh architectures, and/or a variety of roles, such as administrative servers, authentication servers, security monitor servers, data stores for objects such as files and databases, business logic servers, time synchronization servers, and/or front-end servers providing a user-facing interface for the service 102.

Likewise, the local area network 106 may comprise one or more sub-networks, such as may employ different architectures, may be compliant or compatible with differing protocols and/or may interoperate within the local area network 106. Additionally, a variety of local area networks 106 may be interconnected; e.g., a router may provide a link between otherwise separate and independent local area networks 106.

In scenario 100 of FIG. 1, the local area network 106 of the service 102 is connected to a wide area network 108 (WAN) that allows the service 102 to exchange data with other services 102 and/or client devices 110. The wide area network 108 may encompass various combinations of devices with varying levels of distribution and exposure, such as a public wide-area network (e.g., the Internet) and/or a private network (e.g., a virtual private network (VPN) of a distributed enterprise).

In the scenario 100 of FIG. 1, the service 102 may be accessed via the wide area network 108 by a user 112 of one or more client devices 110, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 110 may communicate with the service 102 via various connections to the wide area network 108. As a first such example, one or more client devices 110 may comprise a cellular communicator and may communicate with the service 102 by connecting to the wide area network 108 via a wireless local area network 106 provided by a cellular provider. As a second such example, one or more client devices 110 may communicate with the service 102 by connecting to the wide area network 108 via a wireless local area network 106 provided by a location such as the user's home or workplace (e.g., a WiFi (Institute of Electrical and Electronics Engineers (IEEE) Standard 802.11) network or a Bluetooth (IEEE Standard 802.15.1) personal area network). In this manner, the servers 104 and the client devices 110 may communicate over various types of networks. Other types of networks that may be accessed by the servers 104 and/or client devices 110 include mass storage, such as network attached storage (NAS), a storage area network (SAN), or other forms of computer or machine readable media.

1.2. Server Configuration

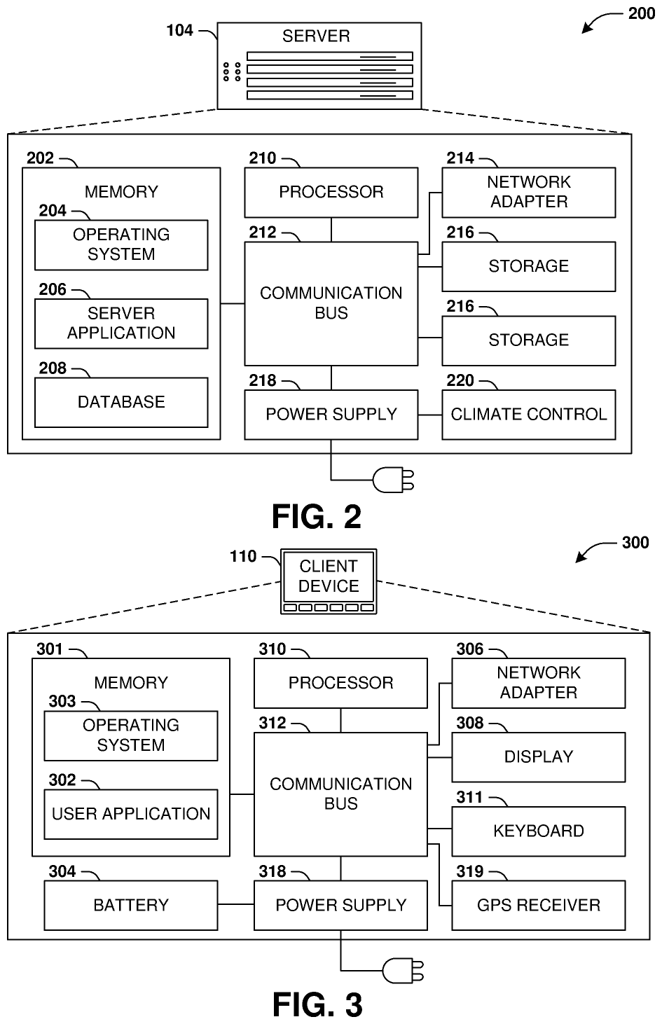

FIG. 2 presents a schematic architecture diagram 200 of a server 104 that may utilize at least a portion of the techniques provided herein. Such a server 104 may vary widely in configuration or capabilities, alone or in conjunction with other servers, in order to provide a service such as the service 102.

The server 104 may comprise one or more processors 210 that process instructions. The one or more processors 210 may optionally include a plurality of cores; one or more coprocessors, such as a mathematics coprocessor or an integrated graphical processing unit (GPU); and/or one or more layers of local cache memory. The server 104 may comprise memory 202 storing various forms of applications, such as an operating system 204; one or more server applications 206, such as a hypertext transport protocol (HTTP) server, a file transfer protocol (FTP) server, or a simple mail transport protocol (SMTP) server; and/or various forms of data, such as a database 208 or a file system. The server 104 may comprise a variety of peripheral components, such as a wired and/or wireless network adapter 214 connectible to a local area network and/or wide area network; one or more storage components 216, such as a hard disk drive, a solid-state storage device (SSD), a flash memory device, and/or a magnetic and/or optical disk reader.

The server 104 may comprise a mainboard featuring one or more communication buses 212 that interconnect the processor 210, the memory 202, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 212 may interconnect the server 104 with at least one other server. Other components that may optionally be included with the server 104 (though not shown in the schematic architecture diagram 200 of FIG. 2) include a display; a display adapter, such as a graphical processing unit (GPU); input peripherals, such as a keyboard and/or mouse; and a flash memory device that may store a basic input/output system (BIOS) routine that facilitates booting the server 104 to a state of readiness.

The server 104 may operate in various physical enclosures, such as a desktop or tower, and/or may be integrated with a display as an “all-in-one” device. The server 104 may be mounted horizontally and/or in a cabinet or rack, and/or may simply comprise an interconnected set of components. The server 104 may comprise a dedicated and/or shared power supply 218 that supplies and/or regulates power for the other components. The server 104 may provide power to and/or receive power from another server and/or other devices. The server 104 may comprise a shared and/or dedicated climate control unit 220 that regulates climate properties, such as temperature, humidity, and/or airflow. Many such servers 104 may be configured and/or adapted to utilize at least a portion of the techniques presented herein.

1.3. Client Device Configuration

FIG. 3 presents a schematic architecture diagram 300 of a client device 110 whereupon at least a portion of the techniques presented herein may be implemented. Such a client device 110 may vary widely in configuration or capabilities, in order to provide a variety of functionality to a user such as the user 112. The client device 110 may be provided in a variety of form factors, such as a desktop or tower workstation; an “all-in-one” device integrated with a display 308; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 110 may serve the user in a variety of roles, such as a workstation, kiosk, media player, gaming device, and/or appliance.

The client device 110 may comprise one or more processors 310 that process instructions. The one or more processors 310 may optionally include a plurality of cores; one or more coprocessors, such as a mathematics coprocessor or an integrated graphical processing unit (GPU); and/or one or more layers of local cache memory. The client device 110 may comprise memory 301 storing various forms of applications, such as an operating system 303; one or more user applications 302, such as document applications, media applications, file and/or data access applications, communication applications such as web browsers and/or email clients, utilities, and/or games; and/or drivers for various peripherals. The client device 110 may comprise a variety of peripheral components, such as a wired and/or wireless network adapter 306 connectible to a local area network and/or wide area network; one or more output components, such as a display 308 coupled with a display adapter (optionally including a graphical processing unit (GPU)), a sound adapter coupled with a speaker, and/or a printer; input devices for receiving input from the user, such as a keyboard 311, a mouse, a microphone, a camera, and/or a touch-sensitive component of the display 308; and/or environmental sensors, such as a global positioning system (GPS) receiver 319 that detects the location, velocity, and/or acceleration of the client device 110, a compass, accelerometer, and/or gyroscope that detects a physical orientation of the client device 110. Other components that may optionally be included with the client device 110 (though not shown in the schematic architecture diagram 300 of FIG. 3) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 110 to a state of readiness; and a climate control unit that regulates climate properties, such as temperature, humidity, and airflow.

The client device 110 may comprise a mainboard featuring one or more communication buses 312 that interconnect the processor 310, the memory 301, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 110 may comprise a dedicated and/or shared power supply 318 that supplies and/or regulates power for other components, and/or a battery 304 that stores power for use while the client device 110 is not connected to a power source via the power supply 318. The client device 110 may provide power to and/or receive power from other client devices.

2. Presented Techniques

One or more systems and/or techniques for providing comparable items for a query item are provided. News stories, memes, and other items can galvanize a reader's attention, convincing them of extreme views about events, ideas, groups of people, and individuals. These items may do this by giving readers the impression that recent events are unprecedented, through innuendo or quotes taken out of context, by making statements that are simply untrue, by highlighting and exaggerating exceptions to general trends, by taking quotes out of context, or by using video editing to support a false narrative. It would be useful if readers could find items that are comparable to such stories, but vary in specific ways. For example, these comparable items may be stories that share a same level of innuendo and on the same topics, but the stories are directed at an opposing party to the subject of the initial story. As another example, these items may be stories that are very similar to today's news, but from the past. This can help people decide how much to let news stories, memes, and other items that they experience affect their views and actions, including whether to post or share them.

Accordingly, as provided herein, comparable items may be identified and provided to users. Items, such as news stories, memes, videos, text, images, and/or a variety of other content, may be evaluated utilizing various types of techniques (e.g., text and image analysis, editorial labeling, crowd sourcing, etc.) to identify characteristics of the items. It may be appreciated that the terms items and media items may be used interchangeably and both refer to content, such as articles, images, videos, text, audio, memes, any other any other type of content. In an example, the characteristics may correspond to veracity/innuendo, editorial opinion vs reporting, political leaning of a subject or a message, tone, whether a topic is a person, an event, or an idea, a subject of the topic, a category of the topic (e.g., videogames, shopping, etc.), a time of the topic, a time at which the item was created, a source or creator of the item, a publisher of the item, etc. The items may be stored within a data structure, such as a database, indexed by the categories and values of the categories.

Given a query item and some specified characteristics (difference characteristics) and optionally values for those characteristics, the system constructs a database query for items. The query is used to perform a search based on a metric that favors items with a same or close characteristics as the query item (similarity characteristics), except for the specified characteristics (difference characteristics). For the difference characteristics, the metric favors differences from the query item, and, if values are specified for those characteristics, then similarity to those values. The query is issued to the database, and the query results are collected and presented the user. The user may be an end user, an author composing a media item that compares items, or an editor selecting sets of items to display together.

In an example, given an item on wearing masks due to a pandemic, difference characteristics may correspond to a time of topic characteristic with a value set to at least twenty years ago in order to find items about wearing masks in past pandemics. In another example, given an item that is a meme with low veracity making accusations about a political party, difference characteristics may correspond to a political leaning of subject characteristic with a value set to be the opposite political leaning of the item's subject and may correspond to a political leaning of message characteristic with a value set to be the opposite political leaning of the item's subject in order to find items that have similarly low veracity and accusations, but with the opposite political leaning. In another example, given an item detailing how society is in trouble because of the weak character and poor habits of the younger generation, a difference characteristic may correspond to a time of topic characteristic, which may be used to find items making similar complaints back to at least the time of the ancient Greece. In another example, a query item may be an article about a first lady wearing an expensive coat. A difference characteristic may be a political leaning characteristic, which may be used to find items criticizing the footwear of a former first lady when another party was in power. In another example, a query item may be an article about books by a particular author being discontinued for a particular political party reasoning. A difference characteristic may be a political leaning characteristic, which may be used to find items about a book by the author being banned by some schools for a different political party reasoning.

In some embodiments, query results of comparable items identified by the query may be displayed along different axes corresponding to their different characteristics that are specified to vary from the original query item. For example, items may be shown left to right in time order and up to down in level of veracity. In some embodiments, augmented reality/virtual reality may be used to show the items along three axes, with the possibility to virtually scroll or walk through time, through veracity levels, and through political leaning of the items, as an example. In some embodiments, for each characteristic, sets of similar values and sets of opposing values are stored. Then, a query item may be specified, and characteristics for which opposing values are desired may be specified as difference characteristics. The system may fill in opposing values automatically for the difference characteristics and similar values for similarity characteristics of the query item. In some embodiments, items may be constructed based on a query. That is, items may be automatically constructed where specified values for some specified characteristics (difference characteristics) are substituted while keeping the other characteristics the same or similar (similarity characteristics). In some embodiments, pairs of characteristic values that are analogies to other pairs of characteristic values may be stored. Given some other characteristic values, the characteristic values are used when pairs of characteristics are specified. For example, “(political leaning=left, topic=riot)<-->(political leaning=right, topic=coup attempt) I tone=accusatory” may be used to replace accusations about riots toward the left with accusations about a coup attempt toward the right.

In some embodiments, given a set of similarities and differences (similarity characteristics and difference characteristics), items closest matched to those similarities and differences may be identified, and then those items are matched or clustered by their similarities on the other features/characteristics. In some embodiments, the clusters may be used to compose a draft media item (e.g., news story, listicle, etc.) comprised of paired summaries and links. A human can then edit the draft media item, or the draft media item can be released automatically for readers to view. In some embodiments, items may be counted based upon similarities and differences, which may identify and display how many items are positive, negative, left, right, etc. For example, counts of positive-right, positive-left, negative-right, negative-left items may be identified and displayed. Also a number of reads and/or width of distribution may be counted.

In some embodiments of item ingestion, items may be ingested into a data structure, such as a database. An identifier generator may associate an item with an item identifier. A scorer may generate property, value, and score metadata triples for the item, which may be inserted into a metadata store as a mapping between the item identifier and property, value, and score metadata triples for the item. Indices may also be used to improve search speed. In an example, items are added to an item store, and data about the items is added to a metadata store via item ingest. The identifier generator produces a unique identifier for the item. The item store maps from identifiers to items, so that items can be retrieved based on their identifiers. Scorers evaluate each item to produce metadata triples, each comprising a property, a value, and a score. The property is a type, the value is a specific instance of the type, and the score is a number. Examples may include: (“publisher”, “Media Publisher ABC”, 1.0), (“topic”, “forest fire”, 0.8), (“subject”, “Socrates”, 0.85), (“tone”, “jovial”, 0.66), (“veracity”, “true”,-0.5), (“political orientation”, “right”,-0.4).

Scorers can be developed using machine learning (e.g., based on natural language programming (NLP), audio/video/image processing, and machine learning/pattern recognition), and may score based on the content of the item, on who reads and reacts to the item, and/or other features. Some scores may be generated by people using either professional evaluators or crowdsourcing. Each metadata triple is called a PVS triple (for property-value-score). The PVS triples are stored in a metadata store, indexed by identifiers of items so that all PVS triples for an item can be retrieved efficiently. The metadata store may also contain other indices to support efficient lookup of sets of PVS triples with a specific property and value and a similar score to a specified PVS triple.

In some embodiments of query formation, PVS triples for an item, default weights (by property, value, user), min and max scores (by property, value, user), and default pivots (by property, value, user) may be used. The following function may be used for query formation: (query set of PVS's) Q={ } For each triple (p_i, v_i, s_i) in PVS triples for item: Get whether to use the triple in the query if so: Get weight for the triple (or use default); Get whether to ask for similar, different, or reflected; if similar, add triple (p_i, v_i, s_i) to Q; if different, ask which direction; if more, then add the triple (p_i, v_i, max score(p i, v_i, user)) to Q; if less, then add the triple (p_i, v_i, min score(p i, v_i, user)) to Q; if reflected, then: Get pivot value or use default pivot value: pivot(p i, v_i, user); add the triple (p_i, v_i, 2*pivot value -s_i) to Q (Note:2*pivot value -s_i=pivot value+(pivot value -s_i), so equally far from the pivot value as s_i, but on the other side of it. This results in Q, default weights (by property, value, user), min and max scores (by property, value, user), and default pivots (by property, value, user). Next, Get whether to add other PVS triples to the query set Q. If so, then repeat: Get property p and value v; Get whether to get score from another item: if so, then get s from that item's PVS triple (p,v,s); if not, then get score; using (p,v,s) in place of (p_i, v_i, s_i) in the previous step, construct a triple to add to Q (similar, different, or reflected); Get whether to repeat (another triple) or continue. This results in Q, default weights. Next, Get whether to use default weights or adjust the weights. This results in Q, weights per PVS triple in Q.

A query may be formed based on a query item in order to identify other items that are similar in some specified ways and different in other specified ways. For this process, an input may be the PVS metadata triples for the item. Another input may be default weights (e.g., numerical values) on a property-value basis (for example 2.0 for (property, value)=(“topic”, “fashion”)) and may also be specified on a more-detailed basis, for example by having weights on a (property, value, user) basis (with specific weights learned over time based on user interaction with the query results) and/or an audience basis, with each audience consisting of a collection of users (with collections defined by demographics, geography, or shared interests, either declared by users or based on observed media consumption). Another input may be minimum and maximum scores for use as query PVS scores, on a property-value basis. Similar to default weights, the scores may also depend on the user/audience. Another input may be default pivots, which are numerical values “center” values used to reflect scores. For example, given a PVS (“political orientation”, “right”, 0.7) and a pivot of 0.1, the PVS with a reflected score is (“political orientation”, “right”,-0.5), because 0.0 is equidistant from 0.7 and -0.5, but in opposite directions. This is useful, for example if an audience has a political “center” denoted by (“political orientation”, “right”, 0.1) and the goal is to locate items that are equally as far from the center as one with PVS (“political orientation”, “right”, 0.7), but in the opposite direction from the center —-left rather than right. Reflection allows search for items that have an opposite political orientation (or other property), yet being similarly as radical or non-radical (in political terms) or otherwise as in the tail of the distribution of scores (for general properties). As for default weights, default pivots are on a property-value basis, and may also be on a user/audience basis.

For each PVS triple in the metadata set for the item (query item0, the query formulator decides whether to: avoid adding a PVS triple based on the PVS triple to the query set Q of PVS triples; add the PVS triple as is to search for media items with similar scores for the property-value; add the PVS triple but get the score for the query triple from another media item that the query formulator specifies; add the PVS triple but with the default minimum score in order to search for media items with the smaller scores for the property-value pair; add the PVS triple but with the default maximum score in order to search for media items with the larger scores for the property-value pair; and/or add the PVS triple but with the reflected score as twice the default pivot minus the PVS triple score. This gives a score value that is reflected across the pivot score from the PVS score: pivot -(score -pivot)=2*pivot −score, which is used to search for media items that are as close to the pivot as the item, but in the opposite direction. Next, the query formulator may add other PVS triples, for example from other media items, and apply the same process to each of those PVS triples as applied to the initial item (query item). Then, the weights are set for the PVS triples in the query set. The query formulator may use the default weight for the property-value in each PVS or edit the weights. A higher weight emphasizes a PVS triple more in the search. The query is a set of PVS triples and a weight for each triple.

In some embodiments, multiple media items (query items) may be used in place of a single initial media item (query item). A union of the sets of PVS triples may be used in place of the set of PVS triples for the single item, but with collisions (same property-value from different items). The query formulator may have the option of selecting among the scores, using the average of the scores or using the median of the scores in order to form a single PVS with that score for the property-value. In some embodiments, multiple sets of media items may be used, and the query formulator may have the option of selecting which set of media items to use for each property-value, along with the options for selecting the score as above if there are multiple PVS triples in the selected group with that property-value (e.g., the average, median, or select among the scores).

In some embodiments of query execution, an input may correspond to: target set of PVS triples (p_i, v_i, s_i), weights w i, requested number of results r, and default scores by property-value. The following function may be used for query execution: result set R={ }; for each media item id in metadata store: fetch media item PVS triples (p_j, v_j, s_j); compute match score: m=0; for each PVS triple (p_i, v_i, s_i) in query: if there is a PVS triple (p_j, v_j, s_j) with p_j=p_i and v_j=v_i, then m=m+w i (s_i -s_j)∧2; otherwise: d=default score for property-value pair (p_i, v_i) and m=m+w i (s_i -d)∧2; collect top r results: if R has fewer than r elements, add (media item id, m) to R; if R has r elements, then while R has an element (media item id′, m′) with m′<m, remove it and add (media item id, m). This results in a result set R of (media item id, match score). This may be used to fetch media items indexed by media item identifiers in R from item store and combined in pairs with a match score. In this way, one or more items/media items may be presented to a user and/or provided for further analysis.

A query is a collection of PVS triples. The query process identifies media items with PVS triples that are the similar to the query triples. Similarity is computed as a weighted sum of squares of differences between scores (a match score) over PVS triples in the query. For each PVS triple in the query, if there is a PVS triple in the metadata for the media item that has the same property and value as the query triple, then the contribution to the sum is the weight for the property-value times the square of the difference between the query score and the media item score. Otherwise, (if there is no property-value match among the media item PVS triples) a default value is used for the media item score. The r media item identifiers with the least match scores (the closest matches to the query) are collected in a result set R. The corresponding media items are fetched from the item store and returned for presentation or analysis.

In some embodiments, a media item may be composed as a list of paired summaries and links with the pair being different in a specific way. For example, some left-leaning articles on various issues may be collected. For each one, the scorers from the ingest process may be used to compute a set of PVS triples, and specify reflection across property=“political orientation” and value=“right” to alter the score for that triple during query formation in order to search for results that are as similar as possible to the media item, except reflected across the political spectrum. The paired media item can either be the top result for the query or an editor may select among multiple results. Viewing the pairs allows a user to experience left- and right-leaning treatments of the same topics. Similarly, a set of media items can be collected about one celebrity. By altering the PVS triple for the one celebrity and substituting one for another celebrity, the system can produce a paired set of media treatments of the two celebrities so a user can observe whether and how the two are treated differently by the press.

In some embodiments, a list of potential reflections (property-value pairs to reflect around) or property-value pairs to minimize or maximize may be stored. For a media item to be displayed to a user and for each potential reflection or min or max, a query may be composed based on the PVS triples for the media item, but with the reflection (or min or max). If there is a sufficiently well-matched query result (according to match score), a link may be displayed next to the media item that indicates the property and value of the reflection, min, or max and links to the result. For example, for an article about wearing a mask during a pandemic, present links to similar media items, but that are reflected in the political spectrum, more historical, more humorous, and more scientific. The user can then select which of those other media items to experience.

In some embodiments, summaries/links to related media items with labels that indicate how they are related (i.e. “reflected in the political spectrum”, “historical”, etc.) for an item produced by a user may be displayed. This enables the user to evaluate how the item they produce relates to media items before they release their item to the media. To do this, scorers are applied to an item, as in the media item ingest process, to get PVS triples for the item. Then those PVS triples are used as in the previous use case.

In some embodiments, virtual reality glasses or goggles may be used to overlay links to media items on a view of the world. Instead of using media items as the basis for the queries, items in the field of view may be used. The links may be labeled by property-value indicators, for example, “history 1789” for a link to a media item about a building in the field of view, with the media item explaining what happened in the building in 1789.

In some embodiments, for a topic and arrays of scores for some property-value pairs, queries are performed for the topic and the combinations of scores from the arrays for the property-value pairs. The summaries and links to the results are placed in a space with axes labeled by the property-value pairs. For example, for the topic “deficit spending,” a query for different times and places on the political spectrum may be performed to identify and display media item links placed in a space with one axis for time periods and the other for left/right political leaning. The user is provided with the ability to rotate axes in and out, such as by substituting humor for history as an axis.

In some embodiments, items may be presented in two or three dimensions using 3D glasses or virtual reality googles.

In some embodiments, for analysis, users can compare result sets and their statistics for different queries. For example, suppose a user wants to know which topics the right and left tend to write about with the most veracity. The user can compose a pair of queries for each of a set of topics of interest with both queries having a PVS triple for the topic but having different PVS triples for political orientation —one with a score indicating right and the other left. Comparing the distribution of veracity scores for the results of the two queries gives an indication of which side of the political spectrum tends to have veracity on that topic (at least among the indexed media items). For another form of analysis, a user can compare the most common property-value pairs among the PVS triples for media items that result from different queries. For example, a user who wants to understand differences between topics for humor in the present versus a previous time period can query for humor among current media items and humor among media items from the previous time period, then a computer can present the user with statistically significant differences between the present and the past, among values for PVS triples with property “topic”, the value, and at least some minimum score.

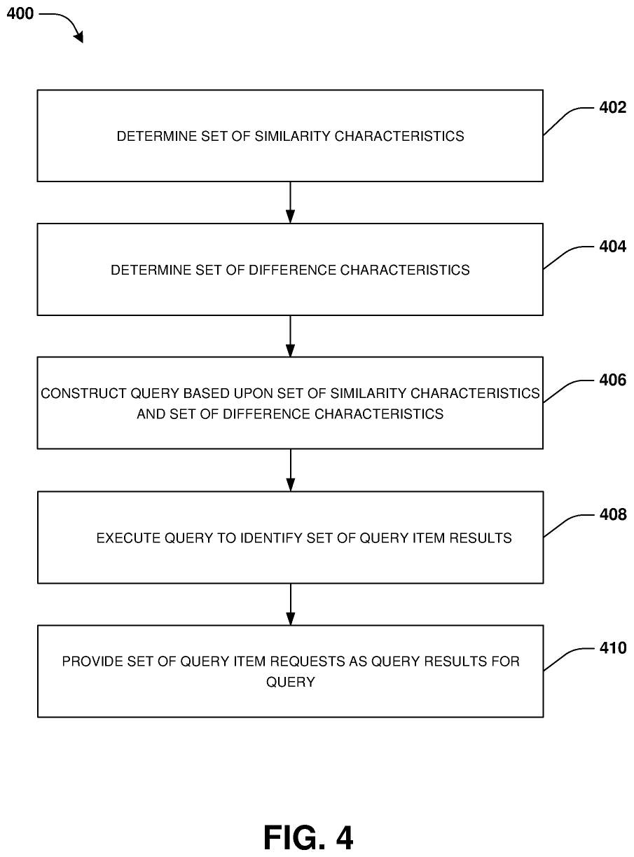

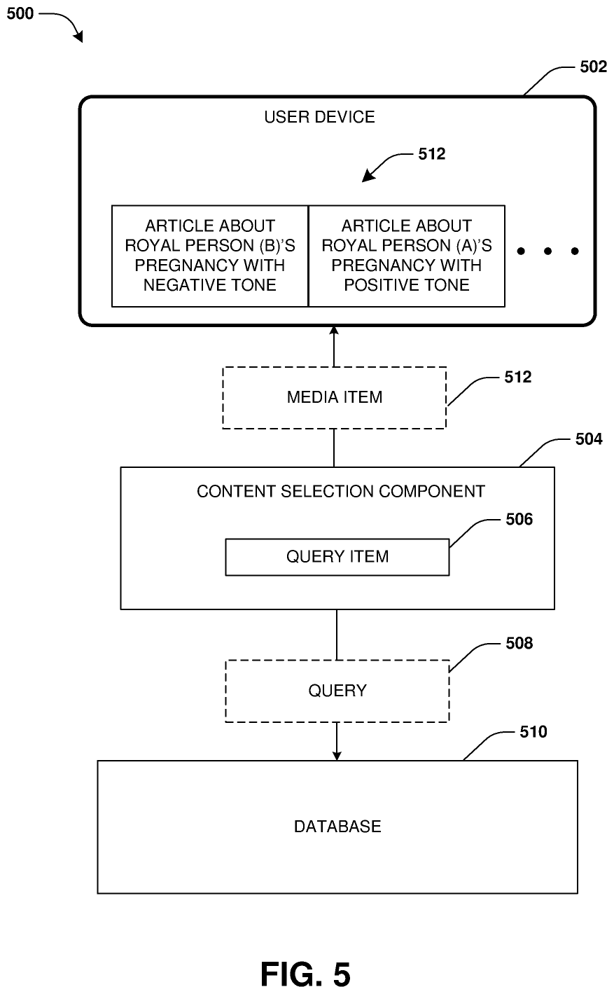

One embodiment of comparable item identification is illustrated by an exemplary method 400 of FIG. 4 and is further described in conjunction with system 500 of FIG. 5. A content selection component 504 may be configured to implement identifier generators, scorers, query formulators, and/or other query processes used to identify and provide comparable items for a query item 506, where these components and processes may implement the previously described techniques. Items, such as articles, images, memes, videos, audio, and/or a variety of other content and media items, may be stored within a database 510. The items may be indexed by characteristics of the items and values of the characteristics. The query item 506 may comprise an item with particular characteristics and values for those characteristics. For example, the query item 506 may comprise an article about a royal person (B)'s pregnancy with a negative tone, and thus the query item 506 may have a negative tone characteristic, a royal person (B) topic characteristic, a pregnancy subject characteristic, etc. The content selection component 504 may be configured to identify comparable items to the query item 506, such as for display through a user device 502.

At 402, the content selection component 504 may determine a set of similarity characteristics for the query item 506. For example, the set of similarity characteristics may correspond to a royal person pregnancy topic that is the same as the query item 506 and a content creator that is the same as the query item 506, which may be characteristics for which comparable items are to be as similar as possible. At 404, a set of difference characteristics for the query item 506 may be determined by the content selection component 505. For example, the set of difference characteristics may correspond to a royal person (B) topic characteristic and a negative tone characteristic, which may be characteristics for which comparable items are to differ as much as possible. In some embodiments, a set of benign characteristics for the query item 506 may be determined, which may correspond to characteristics that provide little to no weight when identifying comparable items.

At 406, the content selection component 504 may construct a query 508 based upon the set of similarity characteristics, the set of difference characteristics, and/or the set of benign characteristics. In some embodiments, the query may be constructed with a metric that favors items with characteristics similar to the set of similarity characteristics. In some embodiments, the query may be constructed with a metric that favors items with characteristics dissimilar to the set of difference characteristics. In some embodiments, the query may be constructed with a metric that disfavors items with characteristics similar to the set of difference characteristics.

At 408, the content selection component 504 may execute the query 508 against the database 510 in order to retrieve a set of query item results comprising items have characteristics similar to the set of similarity characteristics and characteristics different from the set of difference characteristics. For example, the set of query item results may comprise a comparable item that is an article about a royal person (A)'s pregnancy with a positive tone, which may have been written by a same content creator. The comparable item may have characteristics similar to the royal person pregnancy topic that is the same as the query item 506 and the content creator that is the same as the query item 506 of the set of similarity characteristics. The comparable item may have characteristics dissimilar to the royal person (B) topic characteristic and the negative tone characteristic of the set of difference characteristics.

At 410, the set of query item results may be provided as query results for the query 508, such as displayed through the user device 502. For example, the content selection component 504 may construct a media item 512 to comprise the query item 506, the comparable item about the royal person (A)'s pregnancy, and/or other comparable items from the set of query item results, which may be displayed through the user device 502 for comparison between the query item 506 and the comparable items.

In some embodiments, the set of query item results may be displayed along a first axis according to a first characteristic (e.g., creation time) and/or a second axis according to a second characteristic (e.g., increasing positive or negative tone). At least one of the first characteristic or the second characteristic may be a difference characteristic.

In some embodiments, the set of query item results may be displayed along a first axis according to a first characteristic, a second axis according to a second characteristic, and/or a third axis according to a third characteristic. The set of query item results may be displayed and navigable through augmented related, virtual reality, or other type of multi-dimensional display space.

In some embodiments, sets of similar values and sets of differing values for characteristics may be stored. The set of difference characteristics may be automatically filled in using a set of differing values. The set of similar characteristics may be automatically filled in using a set of similar values.

In some embodiments, a submitted query that may be submitted by the user may be received. Items may be constructed as query results for the submitted query by substituting, within the query, a specified value for a first characteristic and/or by retaining a specified value for a second characteristic.

In some embodiments, a first pair of characteristic values that are analogies to a second pair of characteristic values may be stored. In response to the query 508 corresponding to the first pair of characteristic values, the second pair of characteristic values may be included within the query 508.

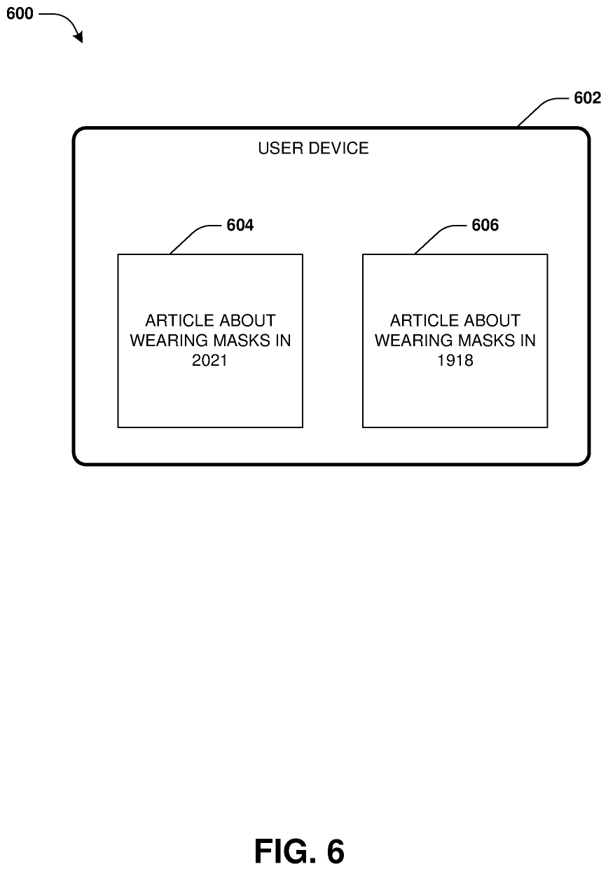

FIG. 6 illustrates an example of query results being provided through a user device 602. A query item 604 may correspond to an article about wearing masks, which may have been written in 2021. A time characteristic may be determined to be a difference characteristic and a wearing masks subject characteristic may be determined to be a similarity characteristic. A query may be constructed based upon the difference characteristic and the similarity characteristic in order to obtain query results having characteristics (values) similar to the similarity characteristic and dissimilar to the difference characteristic. The query results may comprise a query result 606 of an article about wearing masks from 1918. The query item 604, the query result 606, and/or other query results may be displayed through the user device 602.

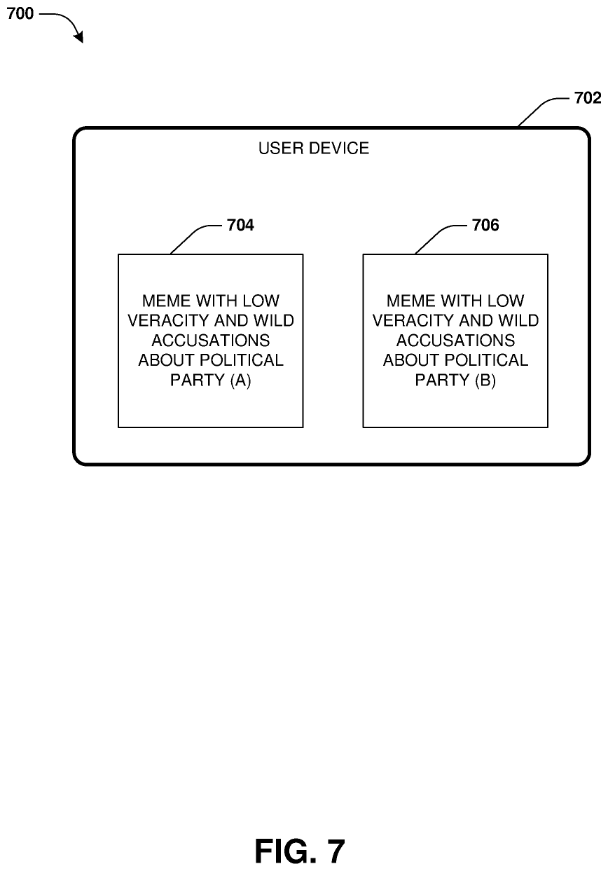

FIG. 7 illustrates an example of query results being provided through a user device 702. A query item 704 may correspond to a meme with low veracity and wild accusations about a political party (A). A political party (A) characteristic may be determined to be a difference characteristic and a low veracity characteristic may be determined to be a similarity characteristic. A query may be constructed based upon the difference characteristic and the similarity characteristic in order to obtain query results having characteristics (values) similar to the similarity characteristic and dissimilar to the difference characteristic. The query results may comprise a query result 706 of a meme with low veracity and wild accusations about a political party (B). The query item 704, the query result 706, and/or other query results may be displayed through the user device 702.

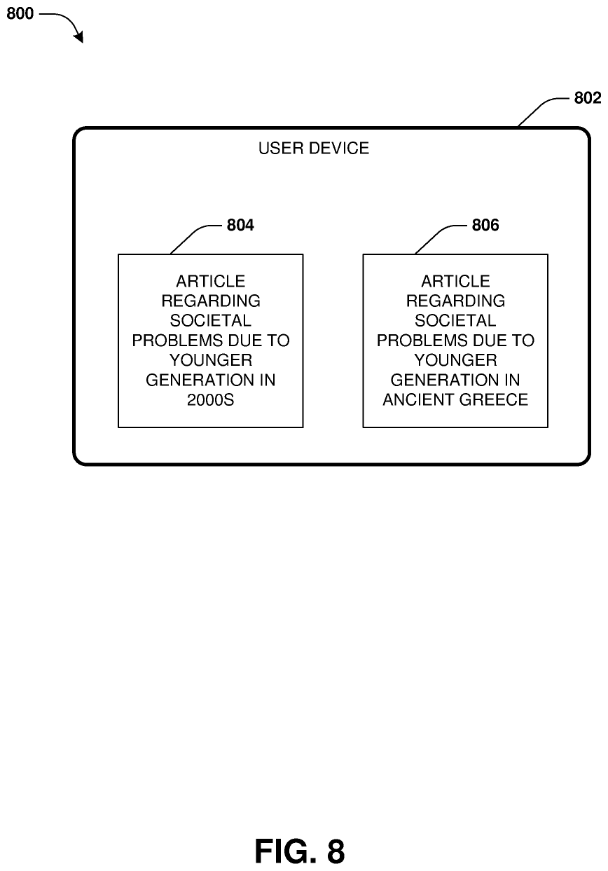

FIG. 8 illustrates an example of query results being provided through a user device 802. A query item 804 may correspond to an article regarding societal problems due to issues with the younger generation, which may have been written in the 2000s. A time characteristic may be determined to be a difference characteristic and a younger generation causing social problems subject may be determined to be a similarity characteristic. A query may be constructed based upon the difference characteristic and the similarity characteristic in order to obtain query results having characteristics (values) similar to the similarity characteristic and dissimilar to the difference characteristic. The query results may comprise a query result 806 of an article about how a philosopher in ancient Greece wrote about how the younger generation is causing societal problems. The query item 804, the query result 806, and/or other query results may be displayed through the user device 802.

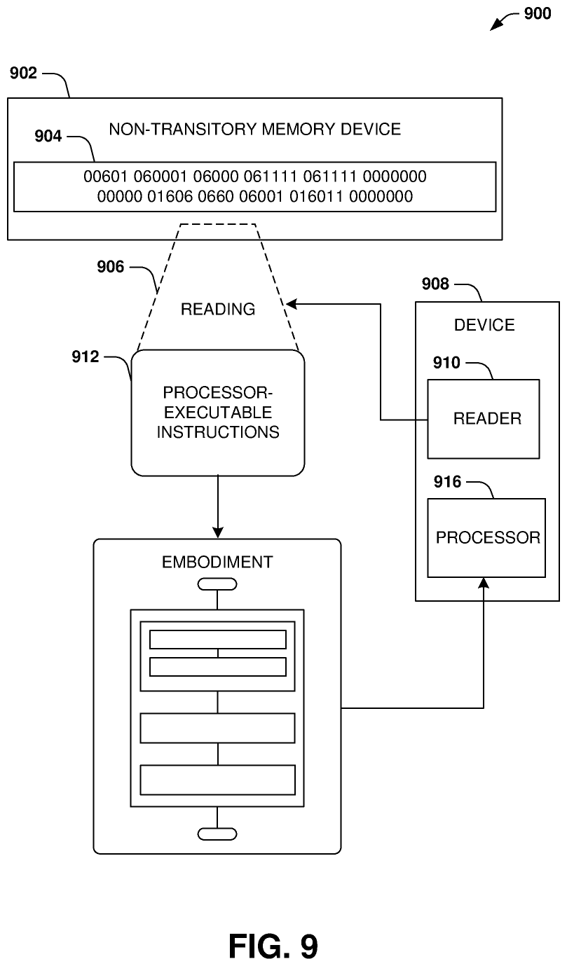

FIG. 9 is an illustration of a scenario 900 involving an example non-transitory machine readable medium 902. The non-transitory machine readable medium 902 may comprise processor-executable instructions 912 that when executed by a processor 916 cause performance (e.g., by the processor 916) of at least some of the provisions herein. The non-transitory machine readable medium 902 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory machine readable medium 902 stores computer-readable data 904 that, when subjected to reading 906 by a reader 910 of a device 908 (e.g., a read head of a hard disk drive, or a read operation invoked on a solid-state storage device), express the processor-executable instructions 912. In some embodiments, the processor-executable instructions 912, when executed cause performance of operations, such as at least some of the example method 400 of FIG. 4, for example. In some embodiments, the processor-executable instructions 912 are configured to cause implementation of a system, such as at least some of the example system 500 of FIG. 5, for example.

3. Usage of Terms

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method, comprising:
executing, on a processor of a computing device, instructions that cause the computing device to perform operations, the operations comprising:
determining a set of similarity characteristics for a query item;
determining a set of difference characteristics for the query item;
constructing a query based upon the set of similarity characteristics and the set of difference characteristics;
executing the query to identify a set of query item results comprising items having characteristics similar to the set of similarity characteristics and characteristics different from the set of difference characteristics; and
providing the set of query item results as query results for the query.

2. The method of claim 1, comprising:
storing items within a database indexed by characteristics of the items and values of the characteristics, wherein the query is executed against the database.

3. The method of claim 1, comprising:
constructing the query with a metric that favors items with characteristics similar to the set of similarity characteristics.

4. The method of claim 1, comprising:
constructing the query with a metric that disfavors items with characteristics similar to the set of difference characteristics.

5. The method of claim 1, comprising:
constructing the query with a metric that favors items with characteristics dissimilar to the set of difference characteristics.

6. The method of claim 1, comprising:
determining a set of benign characteristics for the query item; and
constructing the query based upon the set of benign characteristics.

7. The method of claim 1, wherein the providing comprises:
presenting the set of query item results through a display of the computing device.

8. The method of claim 1, comprising:
constructing a media item comprising the query item and the set of query item results for comparison.

9. A non-transitory machine readable medium having stored thereon processor-executable instructions that when executed cause performance of operations, the operations comprising:
constructing a query based upon a set of similarity characteristics and a set of difference characteristics specified for a query item;
executing the query to identify a set of query item results comprising items having characteristics similar to the set of similarity characteristics and characteristics different from the set of difference characteristics; and
providing the set of query item results as query results for the query.

10. The non-transitory machine readable medium of claim 9, wherein the operations comprise:
displaying the set of query item results along a first axis according to a first characteristic and a second axis according to a second characteristic.

11. The non-transitory machine readable medium of claim 10, wherein at least one of the first characteristic or the second characteristic is a difference characteristic within the set of difference characteristics.

12. The non-transitory machine readable medium of claim 9, wherein the operations comprise:
displaying the set of query item results along a first axis according to a first characteristic, a second axis according to a second characteristic, and a third axis according to a third characteristic.

13. The non-transitory machine readable medium of claim 12, wherein the set of query items are displayed and navigable through at least one of augmented reality or virtual reality.

14. The non-transitory machine readable medium of claim 12, wherein the operations comprise:
storing sets of similar values and sets of differing values for characteristics.

15. The non-transitory machine readable medium of claim 14, wherein the operations comprise:
automatically filling in the set of difference characteristics using a set of differing values.

16. The non-transitory machine readable medium of claim 14, wherein the operations comprise:
automatically filling in the set of similarity characteristics using a set of similarity values.

17. A computing device comprising:
a processor; and
memory comprising processor-executable instructions that when executed by the processor cause performance of operations, the operations comprising:
constructing a query based upon a set of similarity characteristics and a set of difference characteristics specified for a query item;
executing the query to identify a set of query item results comprising items having characteristics similar to the set of similarity characteristics and characteristics different from the set of difference characteristics; and
constructing a media item comprising the query item and the set of query item results for comparison.

18. The computing device of claim 17, wherein the operations comprise:
receiving a submitted query; and
construct items as query results for the submitted query by substituting, within the query, a specified value for a first characteristic and retaining a specified value for a second characteristic.

19. The computing device of claim 17, wherein the operations comprise:
storing a first pair of characteristic values that are analogies to a second pair of characteristic values given other characteristic values.

20. The computing device of claim 19, wherein the operations comprise:
in response to the query corresponding to the first pair of characteristic values, including the second pair of characteristic values within the query.
